(19) United States
(12) Patent Application Publication
(10) Pub. No.: US 2013/0346110 A1
(43) Pub. Date: Dec. 26, 2013

(54) CLINICAL INFORMATION PROCESSING APPARATUS AND CLINICAL INFORMATION PROCESSING PROGRAM

(71) Applicant: FUJIFILM Corporation, Tokyo (JP)

(72) Inventor: Hiroshi Hiramatsu, Tokyo (JP)

(21) Appl. No.: 13/922,163

(22) Filed: Jun. 19, 2013

(30) Foreign Application Priority Data
Jun. 22, 2012 (JP) 2012-140952

(51) Int. Cl. G06F 19/00

(52) U.S. Cl. CPC G06F 19/322
USPC 705/3

(57) ABSTRACT

With respect to a patient whose clinical information is stored in a clinical information storage, plural user groups are set to make the clinical information utilized. With respect to each of the user groups, a history of display-setting used when clinical information about the patient is displayed on a display device by a user belonging to the respective user groups is stored in such a manner to be linked with the respective user groups. An input instruction to display patient's clinical information on a display device by a user belonging to one of the plural user groups is received. A display setting for display of this time is selected from the history of display-setting stored in a display history storage in such a manner to be linked with the one of the plural user groups. The patient's clinical information is displayed on the display device by using the selected display-setting.

### BACKGROUND OF THE INVENTION

1. Field of the Invention

The present invention relates to a clinical information processing apparatus that receives an input of an instruction to display clinical information about a patient on a display device by a user, such as a doctor, and that displays clinical information about the patient stored in a clinical information storage means on the display device. The present invention also relates to a clinical information processing program.

2. Description of the Related Art

In recent years, clinical information management systems became widely used in medical fields. In the clinical information management system, clinical information about a patient, such as a diagnosis record, the content of treatment, and examination data, is stored in a database, and a user can easily retrieve and extract information about the patient, and utilize the information.

Japanese Unexamined Patent Publication No. 6 (1994)-083880 (Patent Document 1) proposes providing display corresponding to each user when the user displays clinical information about a patient at a terminal device. Such display is provided by storing, in advance, a user-specific display setting in which items to be displayed out of all clinical information about a patient are set for each user, and by displaying clinical information about a patient by using the display setting.

Japanese Unexamined Patent Publication No. 2010-003082 (Patent Document 2) proposes making a doctor who has received a consultation request from another clinical department easily check a result of diagnosis by the other clinical department in a clinical institution in which each clinical department displays clinical information about patients by using a clinical-department-specific display setting. When a doctor receives a consultation request from another clinical department, and examines a patient, the clinical information about the patient is displayed by using the display setting of the clinical department that sent the consultation request. Therefore, it is possible to easily check a result of diagnosis by the other clinical department.

### SUMMARY OF THE INVENTION

In recent years, plural doctors, clinical departments, or clinical institutions often cooperate with each other to examine and treat a patient. However, in the methods disclosed in Patent Document 1 and Patent Document 2, clinical information about a patient is displayed by using a doctor-specific display setting or a clinical-department-specific display setting. Therefore, there is a problem that appropriate cooperation is not possible, because clinical information is not well shared with other doctors or other clinical departments. Meanwhile, Patent Document 2 proposes a method of displaying a clinical chart screen of a clinical department that sent a consultation request of a patient to another clinical department when the patient is examined by the other clinical department that has received the consultation request. In this method, a doctor who has received the consultation request may be able to refer to a result of diagnosis in the clinical department that sent the request, but a doctor in the clinical department that sent the request cannot refer to the clinical information about the patient that has been updated by the requested clinical department.

With respect to this problem, for example, clinical information about a patient may be displayed by using the same display method in all clinical departments that are treating the patient. However, in this method, when the patient has plural diseases that are not closely related to each other, and is receiving treatments of respective diseases at different clinical departments, there is a risk of lowering the treatment efficiency at each clinical department on the contrary. For example, when a patient is treated for pancreatic cancer under the cooperation of clinical groups of surgery, internal medicine and radiology, and treated for his/her tooth by a dental clinical group at the same time, if clinical information about the patient is displayed in the same manner in all of the clinical groups, the display includes many kinds of information that are not necessary for each clinical group. Therefore, it becomes difficult to recognize necessary information, and the treatment efficiency becomes lower.

In view of the foregoing circumstances, it is an object of the present invention to provide a clinical information processing apparatus and a clinical information processing program that make it possible to efficiently share clinical information about a patient in each user group unit.

A clinical information processing apparatus of the present invention is a clinical information processing apparatus comprising:

a clinical information storage means that stores clinical information about a patient;

a display history storage means that sets, with respect to the patient whose clinical information is stored in the clinical information storage means, a plurality of user groups to make the clinical information about the patient utilized, and that stores, with respect to each of the set plurality of user groups, a history of display setting used when clinical information about the patient is displayed on a display device by a user belonging to the respective user groups in such a manner that the history is linked with the respective user groups; and

a clinical information display means that receives an input of an instruction to display clinical information about the patient on a display device by a user belonging to one of the plurality of user groups, and that selects a display setting to be used for display of this time from the history of display setting stored in the display history storage means in such a manner to be linked with the one of the plurality of user groups to which the user belongs, and that displays the clinical information about the patient on the display device by using the selected display setting.

Here, a user is a unit of user who uses clinical information about a patient. The term “user” refers to an individual, such as a nurse, a doctor and a patient. A user group is a group (for example, a clinical department) composed of a user or users, as composition elements. The user group is set in such a manner to include at least a user. The user group may be constituted in such a manner to include another user group.

Here, when clinical information about plural patients is stored in the clinical information storage means, the display history storage means may set user groups for all of the plural patients, respectively. Alternatively, the display history storage means may set a user group or groups for a part of the patients (for example, a patient).

Further, the term “display setting” refers to information defining a mode of displaying clinical information on a display device. The display setting includes at least information defining an item or items to be displayed of all clinical information. The display setting may further include a display option, such as arrangement of display of an item or items to be displayed, in addition to the item or items to be displayed.

Further, the term “clinical information” refers to a wide range of information about patient's body conditions, the condition of illness, treatment and the like, which have been obtained during examination and treatment. For example, when a user requests another user or user group to examine and treat a patient, “information about an examination treatment request” representing the requesting user, the requested user or user group, the content of request and the like, and which has been obtained during the process, may also be regarded as the clinical information.

Further, the phrase “an input of an instruction to display clinical information about the patient on a display device” refers to indication of an intention to display clinical information about the patient on the display device. The phrase widely refers to an input that leads to display of the information. Specific examples of the input are an input of information identifying a patient who is a target of clinical information display (a patient ID, a patient name, or the like), an input of an instruction to display clinical information while a target patient is identified, and the like.

In the clinical information processing apparatus of the present invention, the clinical information display means may receive the input of the instruction to display by the user, and select, as the display setting to be used for display of this time, a most recent display setting in the history of display setting stored in the display history storage means in such a manner to be linked with the one of the plurality of user groups to which the user belongs.

In the clinical information processing apparatus of the present invention, the clinical information display means may receive the input of the instruction to display by the user, and display, on a display device, a list of the history of display setting stored in the display history storage means in such a manner to be linked with the one of the plurality of user groups to which the user belongs, and select the display setting to be used for display of this time based on an input by the user specifying an arbitrary display setting in the displayed list.

Further, the display history storage means may receive an input of information about an examination treatment request to another user or user group by a predetermined user belonging to one of the plurality of user groups, and add the other user or user group to the one of the plurality of user groups to which the predetermined user belongs, and which have been set with respect to the patient.

Alternatively, the display history storage means may receive an input specifying another user or user group by a predetermined user belonging to one of the plurality of user groups while clinical information about the patient is displayed on a display device, and add the other user or user group to one of the plurality of user groups to which the predetermined user belongs, and which have been set with respect to the patient.

A clinical information processing program of the present invention is a clinical information processing program for causing a computer to function as:

a clinical information storage means that stores clinical information about a patient;

a display history storage means that sets, with respect to the patient whose clinical information is stored in the clinical information storage means, a plurality of user groups to make the clinical information about the patient utilized, and that stores, with respect to each of the set plurality of user groups, a history of display setting used when clinical information about the patient is displayed on a display device by a user belonging to the respective user groups in such a manner that the history is linked with the respective user groups; and

a clinical information display means that receives an input of an instruction to display clinical information about the patient on a display device by a user belonging to one of the plurality of user groups, and that selects a display setting to be used for display of this time from the history of display setting stored in the display history storage means in such a manner to be linked with the one of the plurality of user groups to which the user belongs, and that displays the clinical information about the patient on the display device by using the selected display setting. The program is provided for a user by being recorded in a recording medium, such as a CD-ROM and a DVD, or by being recorded in a storage attached to a server computer or a network storage in a downloadable manner.

In the clinical information processing program of the present invention, the display history storage means may receive an input of information about an examination treatment request to another user or user group by a predetermined user belonging to one of the plurality of user groups, and add the other user or user group to the one of the plurality of user groups to which the predetermined user belongs, and which have been set with respect to the patient.

In the clinical information processing program of the present invention, the display history storage means may receive an input specifying another user or user group by a predetermined user belonging to one of the plurality of user groups while clinical information about the patient is displayed on a display device, and add the other user or user group to one of the plurality of user groups to which the predetermined user belongs, and which have been set with respect to the patient.

According to the clinical information processing apparatus and the clinical information processing program of the present invention, with respect to a patient whose clinical information is stored in the clinical information storage means, a plurality of user groups are set to make the clinical information about the patient utilized, and with respect to each of the set plurality of user groups, a history of display setting used when clinical information about the patient is displayed on a display device by a user belonging to the respective user groups is stored in such a manner that the history is linked with the respective user groups, and an input of an instruction to display clinical information about the patient on a display device by a user belonging to one of the plurality of user groups is received, and a display setting to be used for display of this time is selected from the history of display setting stored in the display history storage means in such a manner to be linked with the one of the plurality of user groups to which the user belongs, and the clinical information about the patient is displayed on the display device by using the selected display setting. Therefore, the content of clinical information about a patient displayed on display devices is unified in each user group unit. It is possible to efficiently share clinical information about the patient in each user group. Hence, it is possible to enhance close medical cooperation in each user group unit.

In the clinical information processing apparatus and the clinical information processing program of the present invention, when the input of the instruction to display by the user is received, and the most recent display setting in the history of display setting stored in the display history storage means in such a manner to be linked with the one of the plurality of user groups to which the user belongs is automatically selected, as the display setting to be used for display of this time, it is possible to efficiently share the most recent information about the patient in the user group. Therefore, each user belonging to the user group can recognize the most recent condition of the patient, and perform appropriate medical procedures based on the condition of the patient.

In the clinical information processing apparatus and the clinical information processing program of the present invention, when the input of the instruction to display by the user is received, and a list of the history of display setting stored in the display history storage means in such a manner to be linked with the one of the plurality of user groups to which the user belongs is displayed on a display device, and the display setting to be used for display of this time is selected based on an input by the user specifying an arbitrary display setting in the displayed list, a user can display clinical information about the patient by using a display setting that satisfies user's need by a simple operation of selecting a desirable display setting in the displayed list.

In the clinical information processing apparatus and the clinical information processing program of the present invention, when an input of information about an examination treatment request to another user or user group by a predetermined user belonging to one of the plurality of user groups is received, and the other user or user group is added to the one of the plurality of user groups to which the predetermined user belongs, and which have been set with respect to the patient, it is possible to form a user group that shares a history of display setting of the patient with the requested user or user group only by an input of information about an examination treatment request by the requesting user.

In the clinical information processing apparatus and the clinical information processing program of the present invention, when an input specifying another user or user group by a predetermined user belonging to one of the plurality of user groups is received while clinical information about the patient is displayed on a display device, and the other user or user group is added to one of the plurality of user groups to which the predetermined user belongs, and which have been set with respect to the patient, the user can form a user group that shares a history of display setting of the patient by a simple operation of selecting another user or user group while clinical information about a target patient is displayed on a display device.

Note that the program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object and executable code, and can be in any language including higher level languages, assembly language, and machine language.

### BRIEF DESCRIPTION OF THE DRAWINGS

FIG. 1 is a schematic diagram illustrating the configuration of a clinical information processing apparatus according to an embodiment of the present invention;

FIG. 2 is a diagram illustrating an example of a correspondence table stored in a display history database;

FIG. 3 is a diagram illustrating an example of a display screen displaying clinical information about a patient on a display device;

FIG. 4 is a flow chart showing a flow of processing performed by a clinical information processing apparatus (Modified Example 1); and

FIG. 5 is a flow chart showing a flow of processing performed by a clinical information processing apparatus (Modified Example 2).

### DESCRIPTION OF THE PREFERRED EMBODIMENTS

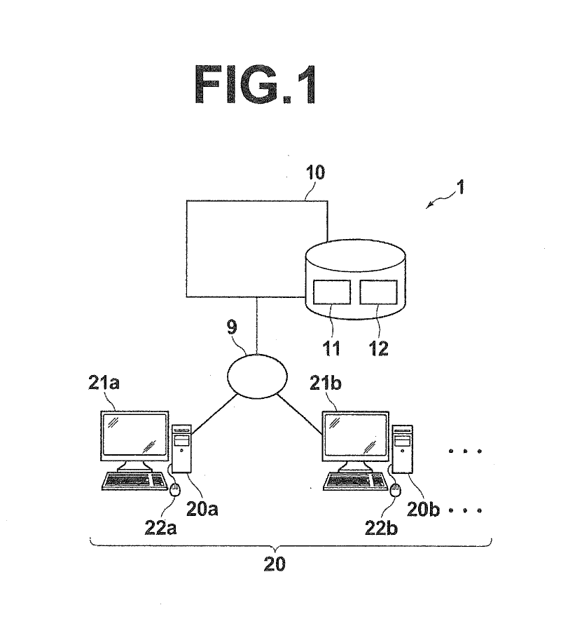

Hereinafter, embodiments of the present invention will be described with reference to drawings. FIG. 1 is a schematic block diagram illustrating the configuration of a clinical information processing apparatus 1 according to an embodiment of the present invention. The clinical information processing apparatus 1 according to an embodiment of the present invention includes a clinical information database 11, a display history database 12, an information management server 10, a client terminal 20 (20a, 20b . . . ) and the like. The clinical information database 11 stores clinical information about a patient. The display history database 12 stores a history or histories of display setting used when a user displayed clinical information about a patient on a display device. The information management server 10 manages the clinical information database 11 and the display history database 12. Each element constituting the clinical information processing apparatus 1 is connected to each other through a network 9. In the embodiment of the present invention, the clinical information database 11 corresponds to a clinical information storage means of the present invention. The information management server 10 and the display history database 12 constitute a display history storage means of the present invention. The information management server 10 and the client terminal 20 constitute a clinical information display means of the present invention.

The clinical information management server 10 is a computer in which a software program providing a function of a database management system (DataBase Management System: DBMS) has been installed. The clinical information management server 10 includes a large capacity storage composed of the clinical information database 11 and the display history database 12. The storage may be a large capacity hard disk drive connected to the clinical information management server 10 through a data bus. Alternatively, the storage may be a disk drive connected to NAS (Network Attached Storage) or SAN (Storage Area Network) connected to a network 9.

The clinical information database 11 stores clinical information about a patient. For example, the clinical information is patient's basic information, such as the height, weight and sex of a patient, the name of a disease that was treated in the past or that is being treated at present, a drug administration history, a treatment result, side effects, results of various kinds of examination, and the like.

The display history database 12 stores correspondence table T for each patient whose clinical information is stored in the clinical information database 11. In the correspondence table T, with respect to each user group that has been set to make the clinical information about the patient utilized, a history of display setting that was used by a user belonging to each user group to display clinical information about the patient is linked with each user group. Setting of a user group will be described later in detail.

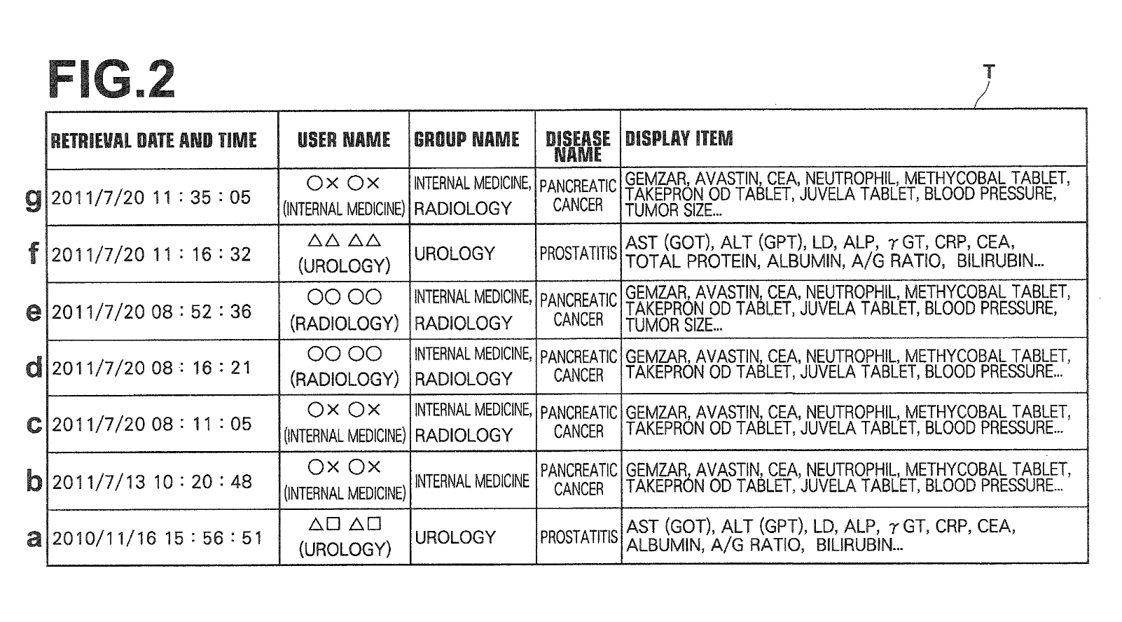

FIG. 2 is a diagram illustrating an example of correspondence table T. The correspondence table T illustrated in FIG. 2 stores information about a retrieval data and time, a user name and a display item or items, as a history of display setting used to display clinical information about patient: Fuji Taro (Patient ID: 0000000000). Each history of display setting is linked with a user group to which the user belongs. In the correspondence table T illustrated in FIG. 2, for example, a history of display setting at retrieval date and time: 2011/7/20, 11:35:05 is linked with a user group composed of a department of internal medicine and a department of radiology. A history of display setting at retrieval date and time: 2011/7/20, 11:16:32 is linked with a user group composed of a department of urology.

The correspondence table T is generated and updated in the following manner. Whenever a user ends a “clinical data observation screen” that displays clinical information about a patient at the client terminal 20, the client terminal 20 sends information, such as a date and time when the screen is ended (retrieval date and time), a list of di splayed item or items and a user ID, to the clinical information management server 10. The clinical information management server 10 makes the format of information received from the client terminal 20 conform to the format of the display history database 2, and registers the information in the display history database 2.

Next, setting of a user group will be described. A user group or groups are set for each patient by the clinical information management server 10. When registration or retrieval of clinical information about a patient whose user group has not been set is requested, or when registration or retrieval of clinical information about a patient with respect to whom one or more user groups have been set is requested by a user who belongs to none of the one or more user groups, the clinical information management server 10 generates a user group composed of a clinical department to which the requesting user belongs.

Further, when one or more user groups have been set for a patient, if user A belonging to one of the one or more user groups inputs information specifying another user or user group B while clinical information about the patient is displayed on a display device of the client terminal 20, the clinical information management server 10 receives information identifying the specified other user or user group B from the client terminal 20, and adds, based on the received information, the other user or user group B to the user group to which the user A belongs, and which has been set for the patient.

For example, while clinical information about a patient is displayed on a display device, if doctor A presses a button of “REQUEST TO OTHER DEPARTMENT” that is displayed on the same display, screen, and specifies other clinical department B, which is a requested department, the clinical information management server 10 adds the clinical department B to a user group to which the doctor A belongs. At this time, the doctor A can efficiently share clinical information about his patient with the other clinical department B that cooperates with the doctor A with respect to a disease or problem of the patient, and closely cooperate with the other clinical department B in medical treatment by specifying the other clinical department B and by adding the other clinical department B to the user group to which the doctor A belongs.

When the clinical information management server 10 receives a request for retrieval of clinical information about a patient from the client terminal 20, the clinical information management server 10 refers to correspondence table T about the patient stored in the display history database 12. Further, the clinical information management server 10 selects the most recent history of display setting stored in such a manner to be linked with a user group to which the user of the client terminal 20 belongs. The clinical information management server 10 retrieves and extracts clinical information from the clinical information database 11 based on the selected display setting. The clinical information management server 10 sends the extracted clinical information to the client terminal 20 that has requested the clinical information.

For example, when a request for retrieval of clinical information about patient: Fuji Taro (Patient ID: 0000000000) is sent from a client terminal 20 of user: ∘∘∘∘ in a department of internal medicine, the clinical information management server 10 refers to correspondence table T illustrated in FIG. 2, and obtains display setting at retrieval date and time: 2011/7/20, 11:35:05, which is the most recent di splay setting in a user group composed of the department of internal medicine and a department of radiology. The clinical information management server 10 retrieves and extracts clinical information from the clinical information database 11 based on the obtained display setting. The clinical information management server 10 sends the extracted clinical information to the client terminal 20 that has requested the clinical information. Similarly, for example, when a request for retrieval of clinical information about patient: Fuji Taro is sent from a client terminal 20 of user: ΔΔΔΔ in a department of urology, the clinical information management server 10 obtains display setting at retrieval date and time: 2011/7/20, 11:16:32, which is the most recent display setting in a user group composed of the department of urology. The clinical information management server 10 retrieves and extracts clinical information from the clinical information database 11 based on the obtained display setting. The clinical information management server 10 sends the extracted clinical information to the client terminal 20 that has requested the clinical information.

The client terminal 20 (20a, 20b . . . ) is a computer (including a smart phone and a tablet computer) used by a doctor in a clinical department to retrieve and input clinical information about a patient, or the like. The client terminal 20 has a known hardware configuration including a CPU, a main storage device, an auxiliary storage device, an input/output interface, a communication interface, input devices (21a, 21b . . . ), display devices (22a, 22b . . . ), a data bus and the like. Further, a known operation system or the like has been installed in the client terminal 20. In the client terminal 20, each processing, such as requesting the clinical information management server 10 to register clinical information, requesting the clinical information management server 10 to retrieve clinical information and displaying clinical information received from the clinical information management server 10, is performed by execution of a software program for each processing.

First, the client terminal 20 lets a user who is authorized to log in input his/her user ID, a password or the like to authenticate the user. If the user is successfully authenticated, a lock is released, and the user can perform various operations. In the embodiment of the present invention, it is assumed that a user who is authorized to log in belongs to one of clinical departments, and that a user belonging to each clinical department that constitutes a user group belongs to the user group.

When a user who has logged in inputs a patient ID of a patient whose clinical information the user wants to retrieve by an input device at the client terminal 20, the client terminal 20 sends the input patient ID and a user ID of the client terminal 20 to the clinical information management server 10 through a network, and requests the clinical information management server 10 to send clinical information. The client terminal 20 receives information sent from the clinical information management server 10 with respect to the request, and displays information on a display device.

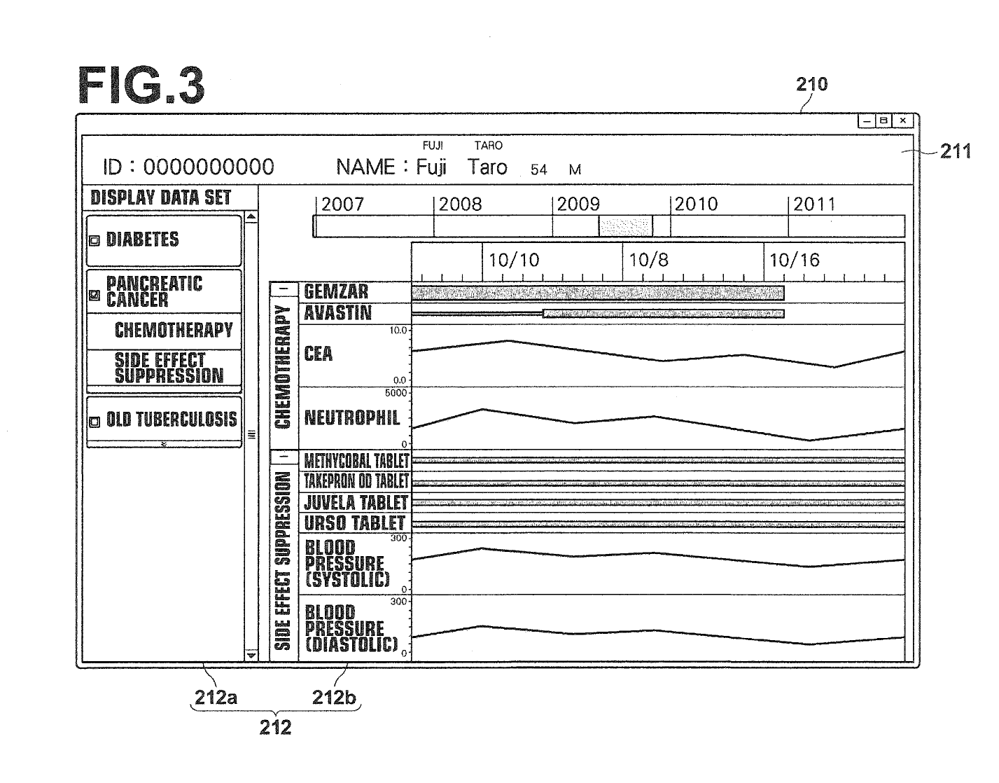

FIG. 3 is a diagram illustrating an example of a display screen in which clinical information about a patient is displayed on a display device. A display screen 210 illustrated in FIG. 3 is information displayed on a display device. A request for retrieval of clinical information about patient: Fuji Taro was sent to the clinical information management server 10 by user: ∘∘∘∘ in the department of internal medicine, and the information was provided by the clinical information management server 10 with respect to the request. The information displayed on the display screen 210 is obtained by using a display setting at retrieval date and time: 2011/7/20, 11:35:05 in the correspondence table T illustrated in FIG. 2.

In the display screen 210, a patient ID and a patient name are displayed in an upper display area 211, and information sent from the clinical information management server 10 is displayed in a display area 212 under the display area 211. Further, the display area 212 is divided into two sections of a left display area 212a and a right display area 212b. In the left display area 212a, a list of names of plural diseases of the patient is displayed, and a disease name in the list is checked when detailed clinical information about the disease is displayed in the right display area 212b. In the right display area 212b, plural items of clinical information are vertically arranged and displayed in graph form the horizontal axis of which represents dates for the plural items. Further, drug administration information about various drugs is displayed in a bar graph. A period of administration of a drug is represented by the length of a bar, and a dose of administration of the drug is represented by the width (thickness) of the bar. Further, results of various kinds of examination are displayed in a line chart, and the scale of the line chart is displayed on the left side axis of the line chart. Here, a case in which the drug administration information and results of examination are displayed in graph form is described as an example. Alternatively, information may be displayed in table form, or display in graph form and display in table form may be used in combination in an appropriate manner.

As described so far, according to the clinical information processing apparatus according to an embodiment of the present invention, with respect to a patient whose clinical information is stored in the clinical information database 11, the information management server 10 sets plural user groups to make clinical information about the patient utilized. Further, with respect to each of the set user groups, a history of display setting used when a user belonging to each user group has displayed clinical information about the patient on a display device is stored in the display history database 12 in such a manner that the history of display setting is linked with the user group. The client terminal receives an input of an instruction to display clinical information about the patient on a display device by a user belonging to one of the plural user groups. Further, the information management server 10 selects a display setting to be used for display of this time from the history of display setting stored in the display history database 12 in such a manner that the history is linked with a user group to which the user belongs. Further, the information management server 10 retrieves and extracts clinical information from the clinical information database 11 by using the selected display setting, and sends the extracted clinical information to the client terminal 20. The client terminal 20 displays the clinical information about the patient sent from the clinical information management sever 10 on the display device. Therefore, the content of clinical information about the patient displayed on a display device is unified in each user group unit. Hence, it is possible to efficiently share clinical information about the patient in each user group, and to enhance close medical cooperation in each user group unit.

For example, when doctor ∘x∘x in the department of internal medicine examined a patient while displaying a clinical data observation screen illustrated in FIG. 3 by using a past display setting (History b illustrated in FIG. 2) in the user group of “INTERNAL MEDICINE” before 2011/7/20, 08:11:05, and sent an examination treatment request to a department of radiology to request image-based diagnosis of pancreatic cancer, “RADIOLOGY” is added to the user group of the “INTERNAL MEDICINE”. After then, when the doctor ∘x∘x in the department of internal medicine ends the clinical data observation screen at 2011/7/20, 08:11:05, History c illustrated in FIG. 2 is formed as a result. This history is managed in such a manner to be shared by the department of internal medicine and the department of radiology, as illustrated in History c in the correspondence table T of FIG. 2.

After then, when doctor ∘∘∘∘ in the department of radiology inputs an instruction to display a screen of clinical information about the patient whose examination and treatment was requested to check the content of the examination treatment request sent from the department of internal medicine after 08:11:05 and before 08:16:21 on 2011/7/20, a clinical data observation screen composed of History c illustrated in FIG. 2 is displayed. History c is the most recent history in the user group to which the user belongs. Accordingly, the doctor ∘∘∘∘ in the department of radiology can easily recognize the condition of the patient that is thought by the doctor in the department of internal medicine who has sent the request. After then, when the doctor ∘∘∘∘ ends the clinical data observation screen at 2011/7/20, 08:16:21, History d illustrated in FIG. 2 is formed as a result.

After then, when doctor ∘∘∘∘ in the department of radiology inputs an instruction to display a screen for clinical information about the patient again after 08:16:21 and before 08:52:36 on 2011/7/20, a clinical data observation screen composed of History d illustrated in FIG. 2 is displayed. History d is the most recent history in the user group to which the user belongs. Then, the doctor ∘∘∘∘ in the department of radiology performs image-based diagnosis as requested. The doctor ∘∘∘∘ adds infatuation about the tumor size of the pancreatic cancer obtained as a result of image-based diagnosis to the display items in the clinical data observation screen. Then, when the clinical data observation screen is ended, History e illustrated in FIG. 2 is formed. As illustrated in FIG. 2, “TUMOR SIZE” is added to the display items of History e.

After then, when doctor ΔΔΔΔ in the department of urology inputs an instruction to display a screen with respect to clinical information about the patient after 08:52:36 and before 11:16:32 on 2011/7/20, a clinical data observation screen composed of History a illustrated in FIG. 2 is displayed. History a is the most recent history in the user group to which the user belongs. Since the doctor ΔΔΔΔ belongs to a user group different from the user group to which doctor ∘x∘x and doctor ∘∘∘∘ belong, the history of the doctor ∘x∘x and the doctor ∘∘∘∘ do not influence the clinical data observation screen of the doctor ΔΔΔΔ. After then, when the doctor ΔΔΔΔ ends the clinical data observation screen at 2011/7/20, 11:16:32, History f illustrated in FIG. 2 is formed as a result.

After then, when doctor ∘x∘x in the department of internal medicine inputs an instruction to display a screen with respect to clinical information about the patient again, a clinical data observation screen composed of History e illustrated in FIG. 2 is displayed. History e is the most recent history in the user group to which the user belongs. The display includes the information about the tumor size that has been added by the department of radiology. Therefore, the doctor ∘x∘x in the department of internal medicine can instantly recognize the clinical information about the patient including the result of the requested image-based diagnosis, which was performed by the department of radiology.

Further, according to the clinical information processing apparatus according to an embodiment of the present invention, the client terminal 20 receives an input of an instruction to display by a user, and the clinical information management server 10 automatically selects, as the display setting to be used for display, the most recent display setting in the history of display setting stored in the display history database 12 in such a manner to be linked with the user group to which the user belongs. Therefore, it is possible to efficiently share the most recent information about the patient in the user group. Further, each user belonging to the user group can recognize the most recent condition of the patient, and perform appropriate medical procedures based on the most recent condition of the patient.

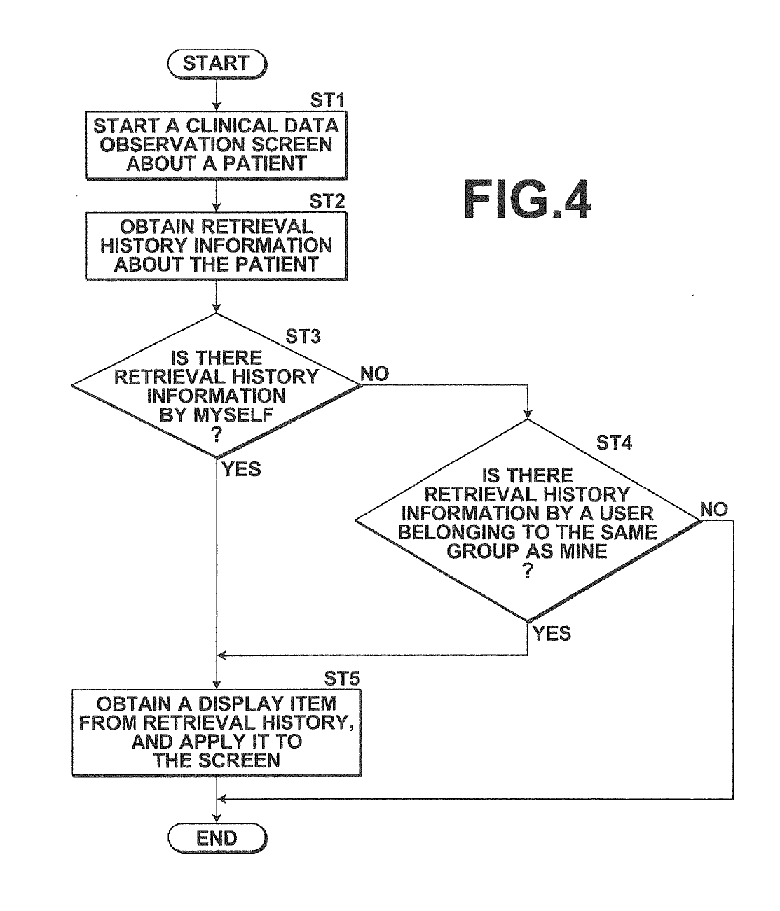

In the embodiment of the present invention, a case in which the clinical information management server 10 that has received a request for retrieval of clinical information about a patient from a user automatically selects the most recent display setting in the history of display setting stored in the display history database 12 in such a manner to be linked with the user group to which the user belongs was described. When the history of di splay setting includes a history of display setting by the user himself, priority may be given to selection of the display setting of the history of the user him/herself over the other display settings. With reference to the flow chart illustrated in FIG. 4, an example of processing performed by the clinical information processing apparatus to realize such processing will be described.

As illustrated in the flow chart of FIG. 4, first, the client terminal 20 receives an input of an instruction to start a clinical data observation screen of a patient by a user (ST1). Then, retrieval history information about the patient is received from the display history database 12 (ST2), and judgment is made as to whether there is history information about retrieval by the user him/herself (ST3). In the judgment, if it is judged that there is history information about retrieval by the user him/herself (ST3: YES), a display item or items are obtained from the clinical information database 11 based on the history information about retrieval by the user him/herself. Further, clinical information of the obtained item or items is displayed on the clinical data observation screen (ST5), and processing ends.

In contrast, if it is judged that there is no history information about retrieval by the user him/herself in the judgment of step ST3 (ST3: NO), judgment is made as to whether there is history information about retrieval by another user belonging to the same user group as the user him/herself (ST4). In the judgment, if it is judged that there is history information about retrieval by the other user belonging to the same user group as the user him/herself (ST4: YES), a display item or items are obtained from the clinical information database 11 based on the history information about retrieval by the other user belonging to the same user group as the user him/herself. Further, clinical information of the obtained item or items is displayed on the clinical data observation screen (ST5), and processing ends. In contrast, if it is judged that there is no history information about retrieval by the other user in step ST4, processing ends immediately.

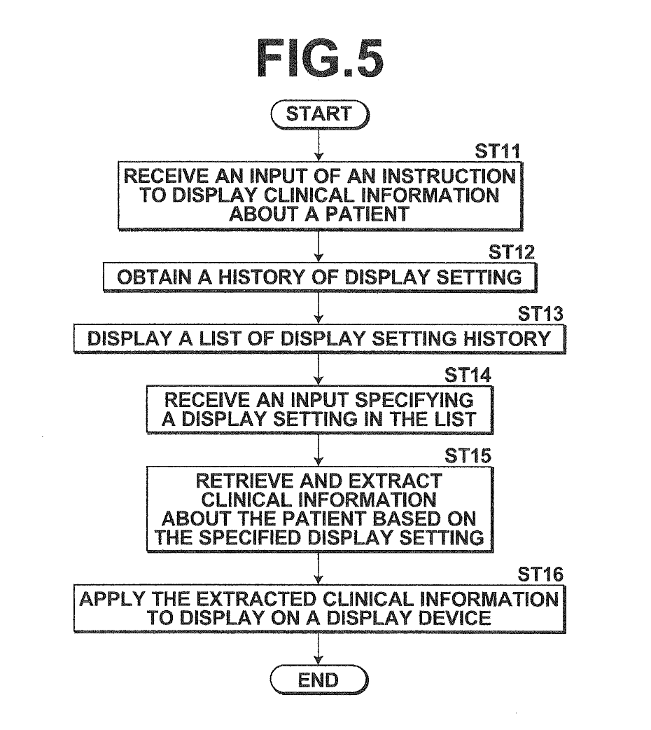

In the clinical information processing apparatus according the embodiment of the present invention, the clinical information management server 10 may receive a request for retrieval of clinical information about a patient from a user, and display, on a display device, a list of history of display setting stored in the display history database 12 in such a manner to be linked with a user group to which the user belongs to, and select, as a display setting used in display of this time, a display setting specified by an input by the user. The input by the user specifies an arbitrary display setting in the displayed list. With reference to the flow chart illustrated in FIG. 5, an example of processing performed by the clinical information processing apparatus to realize such processing will be described.

As illustrated in the flow chart of FIG. 5, first, the client terminal 20 receives an input of an instruction to display clinical information about a patient by a user (ST11). Information identifying the patient (for example, patient ID) and information identifying the user (for example, user ID) are sent to the clinical information management sever 10, and requests the clinical information management server 10 to send clinical information about the patient. Then, the information management server 10 obtains a history or histories of display setting stored in such a manner to be liked with a user group to which the user belongs from histories of display setting about the patient stored in the display history database 12, and sends the obtained history or histories to the client terminal 20 (ST12).

Then, the client terminal 20 displays a list of history of display setting sent from the information management server 10 on a display device (ST13). The client terminal 20 receives an input by the user that specifies an arbitrary display setting in the displayed list, and sends information identifying the specified display setting to the information management server 10 (ST14). At this time, for example, the user may select a specific retrieval history from the list of history of display setting displayed on the display device, and a desirable display setting may be specified by performing an operation of pressing “REGENERATE DISPLAY ITEM”. Then, the information management server 10 retrieves and extracts corresponding clinical information from the clinical information database 11 based on the specified display setting, and sends the extracted clinical information to the client terminal (ST15). The client terminal 20 receives clinical information about the patient sent from the information management server 10, and displays the information on a display device (ST16), and processing ends.

Here, a case in which the information management server 10 provides the client terminal 20 with only histories of display setting linked with the user group to which the user belongs out of stored histories of display setting about the patient, and displays a list of the history of display setting in such a manner that an arbitrary display setting is selectable in the list has been described. Alternatively, the information management server 10 may provide the client terminal 20 with all histories of display setting stored about the patient, and display them as a list so that a user can flexibly select also a display setting stored in such a manner to be linked with a user group other than the user group to which the user belongs.

In the embodiment of the present invention, a case in which a user group is composed of one or more clinical departments was described as an example. Alternatively, a user group may be composed of an individual, such as a nurse, a doctor and a patient, or a user group may be a group composed of two or more individuals (for example, a clinical department). A user group may be composed of a combination of an individual and a group. For example, all members in charge of a patient for a disease may be regarded as a user group. Alternatively, members in charge of the same patient for the same disease may be divided into different groups based on their roles. For example, a doctor group and a nurse group which are in charge of the same patient for the same disease may be separate user groups.

What is claimed is:

1. A clinical information processing apparatus comprising:
a. clinical information storage means that stores clinical information about a patient;
a display history storage means that sets, with respect to the patient whose clinical information is stored in the clinical information storage means, a plurality of user groups to make the clinical information about the patient utilized, and that stores, with respect to each of the set plurality of user groups, a history of display setting used when clinical information about the patient is displayed on a display device by a user belonging to the respective user groups in such a manner that the history is linked with the respective user groups; and
a clinical information display means that receives an input of an instruction to display clinical information about the patient on a display device by a user belonging to one of the plurality of user groups, and that selects a display setting to be used for display of this time from the history of display setting stored in the display history storage means in such a manner to be linked with the one of the plurality of user groups to which the user belongs, and that displays the clinical information about the patient on the display device by using the selected display setting.

2. A clinical information processing apparatus, as defined in claim 1, wherein the clinical information display means receives the input of the instruction to display by the user, and selects, as the display setting to be used for display of this time, a most recent display setting in the history of display setting stored in the display history storage means in such a manner to be linked with the one of the plurality of user groups to which the user belongs.

3. A clinical information processing apparatus, as defined in claim 1, wherein the clinical information display means receives the input of the instruction to display by the user, and displays, on a display device, a list of the history of display setting stored in the display history storage means in such a manner to be linked with the one of the plurality of user groups to which the user belongs, and selects the display setting to be used for display of this time based on an input by the user specifying an arbitrary display setting in the displayed list.

4. A clinical information processing apparatus, as defined in claim 1, wherein the display history storage means receives an input of information about an examination treatment request to another user or user group by a predetermined user belonging to one of the plurality of user groups, and adds the other user or user group to the one of the plurality of user groups to which the predetermined user belongs, and which have been set with respect to the patient.

5. A clinical information processing apparatus, as defined in claim 1, wherein the display history storage means receives an input specifying another user or user group by a predetermined user belonging to one of the plurality of user groups while clinical information about the patient is displayed on a display device, and adds the other user or user group to one of the plurality of user groups to which the predetermined user belongs, and which have been set with respect to the patient.

6. A non-transitory computer-readable recording medium having stored therein a clinical information processing program for causing a computer to function as:
a clinical information storage means that stores clinical information about a patient;
a display history storage means that sets, with respect to the patient whose clinical information is stored in the clinical information storage means, a plurality of user groups to make the clinical information about the patient utilized, and that stores, with respect to each of the set plurality of user groups, a history of display setting used when clinical information about the patient is displayed on a display device by a user belonging to the respective user groups in such a manner that the history is linked with the respective user groups; and
a clinical information display means that receives an input of an instruction to di splay clinical information about the patient on a display device by a user belonging to one of the plurality of user groups, and that selects a display setting to be used for display of this time from the history of display setting stored in the display history storage means in such a manner to be linked with the one of the plurality of user groups to which the user belongs, and that displays the clinical information about the patient on the display device by using the selected display setting.

7. A non-transitory computer-readable recording medium, as defined in claim 6, wherein the display history storage means receives an input of an examination treatment information to another user or user group by a predetermined user belonging to one of the plurality of user groups, and adds the other user or user group to the one of the plurality of user groups to which the predetermined user belongs, and which have been set with respect to the patient.

8. A non-transitory computer-readable recording medium, as defined in claim 6, wherein the display history storage means receives an input specifying another user or user group by a predetermined user belonging to one of the plurality of user groups while clinical information about the patient is displayed on a display device, and adds the other user or user group to one of the plurality of user groups to which the predetermined user belongs, and which have been set with respect to the patient.
